(19) United States
(12) Patent Application Publication
(10) Pub. No.: US 2012/0130870 A1
(43) Pub. Date: May 24, 2012

(54) METHOD AND SYSTEM FOR BUDGET MANAGEMENT

(75) Inventors: Jaidev Shergill, New York, NY (US); Michele Serro, New York, NY (US); Shiv Bir Singh, New York, NY (US)

(73) Assignee: BUNDLE CORPORATION, New York, NY (US)

(21) Appl. No.: 12/951,646

(22) Filed: Nov. 22, 2010

(51) Int. Cl. G06Q 40/00

(52) U.S. Cl. 705/30

(57) ABSTRACT

Provided are methods, systems and computer programs for managing finances such as personal budgets.

### BACKGROUND

The present application generally relates to computer programs for managing financial information such as budget information.

Several computer software programs have been designed that help a user track quantifiable financial information such as budgetary information. See, e.g., U.S. Pat. Nos. 5,245,535, 6,012,044, 6,064,984, and 7246110; U.S. Patent Application Publications 20030014331, 20060143072, 20070174163, 20080235073, 20090144117, 20090216597, and 20090271287; and PCT Publications WO2002091225 and WO2002097561. The methods, systems and computer programs disclosed herein provide an alternative to those programs with the use of interactive, intuitive displays, with other features to help the user understand the information.

### SUMMARY

Provided herewith are methods, systems and computer programs for managing personal budgets. In some embodiments, a method implemented using a processor, a memory and a display device for managing a budget of a user is provided. The method comprises (a) obtaining information regarding at least two budgetary categories where finances of the user are to be allocated, and an amount of the finances to be allocated in the at least two budgetary categories; (b) presenting the budgetary categories to the user via the display device; (c) determining a budget for the user during a predetermined time period for the at least two budgetary categories using the obtained information; (d) obtaining data regarding financial activity by the user during the predetermined time period in the at least two budgetary categories; (e) using the processor to determine whether the user financial activity during the predetermined time period in the at least two budgetary categories exceeds or is likely to exceed the calculated budget; and (f) notifying the user when the user financial activity during the predetermined time period in a first of the at least two budgetary categories exceeds or is likely to exceed the calculated budget.

Also provided is a system for managing a budget of a user. The system comprises (a) a processor, wherein the processor (i) runs a software application that obtains information regarding at least two budgetary categories where finances of the user are to be allocated, and an amount of the finances to be allocated in the at least two budgetary categories; (ii) presents the budgetary categories to the user; (iii) determines a budget for the user during a predetermined time period for the at least two budgetary categories using the obtained information; (iv) obtains data regarding financial activity by the user during the predetermined time period in the at least two budgetary categories; (v) determines whether the user financial activity during the predetermined time period in the at least two budgetary categories exceeds or is likely to exceed the calculated budget; and (iv) notifies the user when the user spending during the predetermined time period in a first of the at least two budgetary categories exceeds or is likely to exceed the calculated budget; (b) a database coupled to the processor, wherein the database resides in at least one memory and stores the budget in the at least two budgetary categories; and (c) a display coupled to the processor, wherein the display presents the budgetary categories to the user and presents the notification from the processor to the user.

Further provided is a computer program product to be used with a processor and a display. The computer program product comprises a computer usable medium comprising computer readable program code directing the processor to (a) obtain information regarding at least two budgetary categories where finances of a user are to be allocated, and an amount of the finances to be allocated in the at least two budgetary categories; (b) present the budgetary categories to the user on the display; (c) determine a budget for the user during a predetermined time period for the at least two budgetary categories using the obtained information; (d) obtain data regarding financial activity by the user during the predetermined time period in the at least two budgetary categories; (e) determine whether the user financial activity during the predetermined time period in the at least two budgetary categories exceeds or is likely to exceed the calculated budget; and (f) notify the user on the display when the user spending during the predetermined time period in a first of the at least two budgetary categories exceeds or is likely to exceed the calculated budget.

### BRIEF DESCRIPTION OF THE DRAWINGS

FIG. 1 is a flowchart of a method in accordance with an illustrated embodiment.

FIG. 2 is an output display of a method, system and computer program in accordance with an illustrative embodiment.

FIG. 3 is an output display of a method, system and computer program in accordance with an illustrative embodiment.

FIG. 4 is an output display of a method, system and computer program in accordance with an illustrative embodiment.

FIG. 5 is an output display of a method, system and computer program in accordance with an illustrative embodiment.

FIG. 6 is a flowchart illustrating a process for displaying and evaluating budgetary information.

### DETAILED DESCRIPTION

The terminology used herein is for describing particular embodiments only and is not intended to be limiting of the invention. As used herein, the singular forms “a”, “an” and “the” are intended to include the plural forms as well, unless the context clearly indicates otherwise. In addition, as referenced herein, a module is defined as hardware, software, and/or a combination thereof for performing a particular function. Software is defined as computer executable instructions including, but not limited to, object code, assembly code, and machine code. Hardware may include, but is not limited to, one or more processors/microprocessors, electronic circuitry, and other physical components. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof.

The methods, systems and programs disclosed herein provides a way of evaluating and manipulating budgets. These methods, systems and programs can be used as a stand-alone application or can be used with other financial software, for example that described in co-pending U.S. patent application Ser. No. ______, titled “Method and System for Displaying Financial Information,” filed concurrently, and incorporated herein by reference in its entirety.

In some embodiments a method implemented using a processor, a memory and a display device for managing a budget of a user is provided. The method comprises (a) obtaining information regarding at least two budgetary categories where finances of the user are to be allocated, and an amount of the finances to be allocated in the at least two budgetary categories; (b) presenting the budgetary categories to the user via the display device; (c) determining a budget for the user during a predetermined time period for the at least two budgetary categories using the obtained information; (d) obtaining data regarding financial activity by the user during the predetermined time period in the at least two budgetary categories; (e) using the processor to determine whether the user financial activity during the predetermined time period in the at least two budgetary categories exceeds or is likely to exceed the calculated budget; and (f) notifying the user when the user financial activity during the predetermined time period in a first of the at least two budgetary categories exceeds or is likely to exceed the calculated budget.

As used herein, “budgetary categories” is categories under which budgetary allocations are made. Nonlimiting examples of demographic categories are Groceries, Dining out, Clothing & Shoes, Fixed & Other, Credit Card Payoff, and Goals and Savings. In one example of the method of these embodiments, a budget is created where finances of the user are allocated into selected budgetary categories according to how the user expects to use the finances. Examples of financial activities under which budgets are created are spending, payment of loans, fixed expenses, investments, savings, and goals.

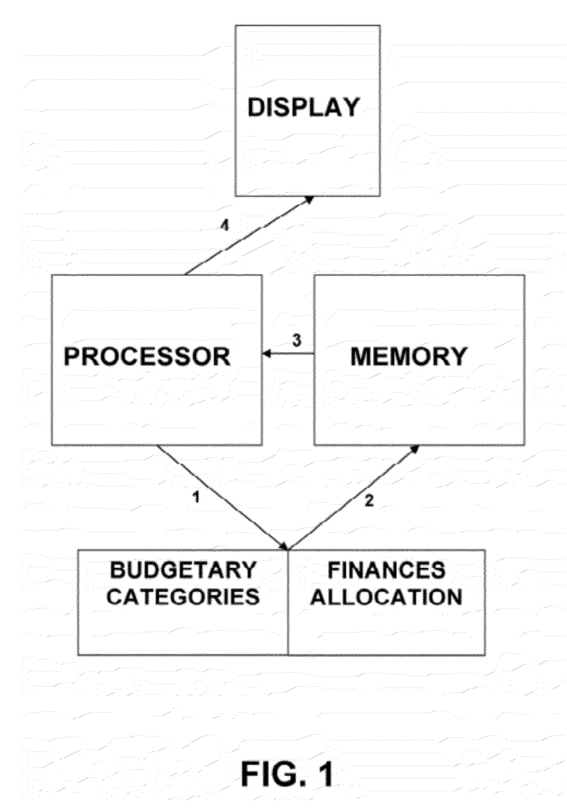

FIG. 1 provides a flowchart for these embodiments where budgetary information is being processed. In step 1, the processor obtains information regarding user budgetary categories and how the user's finances are allocated into budgets. In some cases, the allocation of finances for a budgetary category can be zero, e.g., when the user does not expect to make purchases in the category but may in the future. In various embodiments, the user's finances allocated to the budget is the user's total income, either take-home income or gross income. In the latter case, deductions can be allocated to separate budgetary categories, e.g., a category for taxes withheld and/or quarterly tax payments, a category for deducted medical insurance, etc. By including these fixed expenses into budgetary categories, the user can determine how those deductions affect the total budget and can, in some cases, adjust those expenses, e.g., by obtaining a lower cost medical insurance policy.

In step 2 of the method illustrated in FIG. 1, the information is stored in a memory, where it may be retrieved by the processor (step 3) to calculate the budget for each of the budgetary categories, which is then displayed on the display device (step 4).

In some embodiments, the information about the budgetary categories and finances allocation is at least partially obtained from at least one database, for example a database that comprises a financial account of the user. The database can also be a database that provides averages of financial activity in the budgetary categories by people in a similar socioeconomic class as the user. In that instance, the budgets can be created automatically by the processor based on these averages.

In other embodiments, the information is at least partially obtained from the user, e.g., in response to a query on the display device requesting input from the user. Here, the user specifies the amount of the user finances that are allocated in each budgetary category.

In various embodiments, the information is obtained from the user by posing questions on the display, e.g., “How much did you spend on groceries?” In other embodiments, the user uses a pointer to click on button(s) or other links in a menu or on another part of the display to bring up a prompt requesting input of the amount spent. In still other embodiments, the information is obtained at least in part by going to a database, either on the user's computer or on a remote computer (e.g., on a website, for example the user's bank or credit card website) to retrieve data about the user's spending. In various embodiments, the purchases are then automatically categorized into demographic categories (e.g., the program assumes that a purchase from Payless Shoes would be categorized into the “Clothing & Shoes” category), subject to recategorization by the user. Alternatively, the data may be stored in a default location for a period of time or until the data can be categorized.

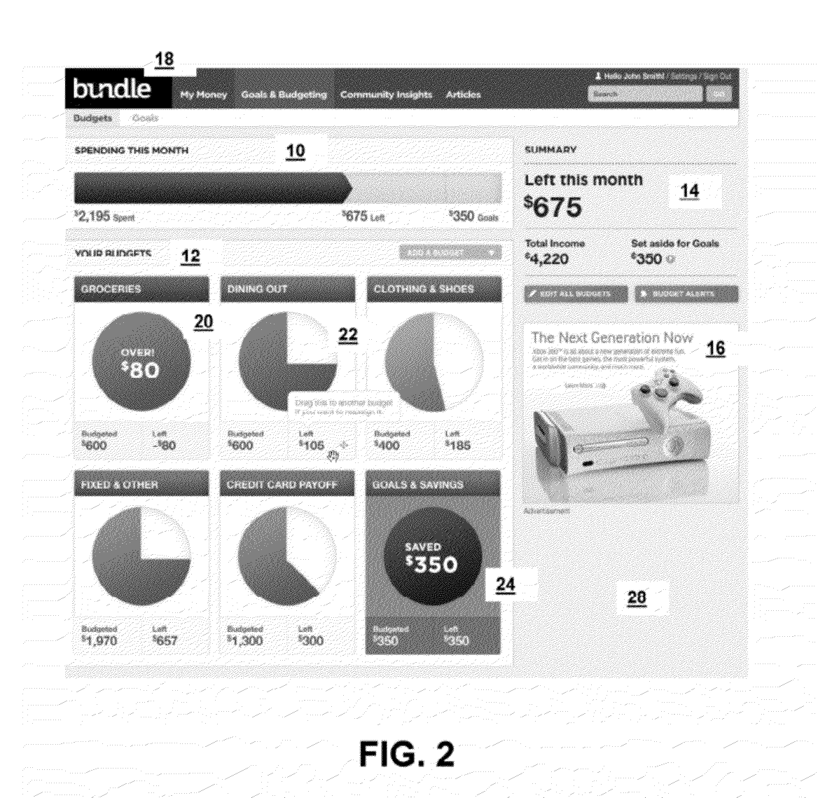

FIG. 2 shows a typical output on a display device for these embodiments. In the embodiment illustrated therein, the method is provided as a module of a financial program “Bundle” as indicated by the menu 18 along the top of the display. The instant method is accessed under the “Goals & Budgeting” tab. The Bundle program provides further financial analysis, accessed by clicking the “My Money” tab, and further described in U.S. patent application Ser. No. ______, titled “Method and System for Displaying Financial Information.” The Community Insights and Articles tabs provide access to information related to personal finances. This accessory financial information can include e.g., links to articles, statistical data, advice about financial choices, observations relating to the user's spending habits, or promotional materials.

Below the Bundle menu is the Budgets and Goals tabs, providing access to the rest of the instant display under the Budget tab, and further analysis of personal goals, as further described below, under the Goals tab.

The rest of the menu is divided into four areas, marked 10, 12, 14 and 16. Area 10, labeled “SPENDING THIS MONTH” shows a bar divided into “Spent” and “Left” categories, where the “Goals” budget for the month ($350) is also indicated. The bar under area 10 provides the user with an instant assessment of the amount that the user can spend during the month and still remain within the budget. In some embodiments, the user can select which budgetary categories are included in the bar.

Area 12 provides pie charts for each budgetary category, including information about how much is used and how much is left in the budget for each category. Where the budget for a particular category has been exceeded, the exceeded budget is so indicated, e.g., as with the Grocery budget 20. In the illustrated embodiments, the budget for each budgetary category is shown on the display device as a circle capable of being sectioned as a pie chart to indicate a proportion of budget that is spent during a particular designated time period. That information can alternatively be displayed in any other manner, e.g., as subdivided bars as under area 10 or as bar graphs. The budget can also be shown on the display device as a first shape, such as, for example, a circle (as in FIGS. 2-5), an oval, a square, a rectangle, a triangle, a pentagon, a hexagon, a heptagon, an octagon, or a parallelogram. In some of these embodiments, the size of the first shape corresponds to the relative value of the budget such that a larger shape corresponds to a larger value. In other embodiments, as in FIGS. 2-5, the size of the first shape for each budget is the same. In various embodiments, the first shape is divided into a used portion and an unused portion in response to the user spending in the at least one demographic category during the predetermined time period. For example, in FIGS. 2-5, the first shape is a circle that is divided as a pie chart to indicate a proportion of budget that is spent in the budgetary category during the predetermined time period. In certain embodiments, the first shape comprises a smaller shape within the first shape, where the smaller shape represents the unspent portion.

Area 14 provides a basic summary showing “Total Income”, amount remaining (“Left this month”) and the amount “Set aside for Goals”. Optionally, other summary information can be displayed in this area. In some embodiments, the Total Income figure or other financial information can be obtained from another program, or from another module of the same program, e.g., the My Money module of the Bundle program, as described in U.S. patent application Ser. No. ______, titled “Method and System for Displaying Financial Information.”

Advertisements from a sponsored vendor can also be displayed in the output for these embodiments, as provided in area 16. Additionally, the empty area 28 can alternately display any other information, for example, accessory information that can be related to finances related information that is identified as an area of interest or concern. That area can also display a window into another program running or another module of a program to which the instant method is a part (e.g., the My Money module of the Bundle program).

In some embodiments, a portion of the budget is moved from a second budgetary category to a first budgetary category to increase the allocated amount in the first budgetary category if user financial activity during a predetermined time period (e.g., a month) in the first budgetary category exceeds or is likely to exceed the calculated budget. In these embodiments, the portion of the budget is moved when a predetermined condition is met. In various embodiments, the predetermined condition is met by the user instructing the processor to move the portion of the budget from the second budgetary category to the first budgetary category.

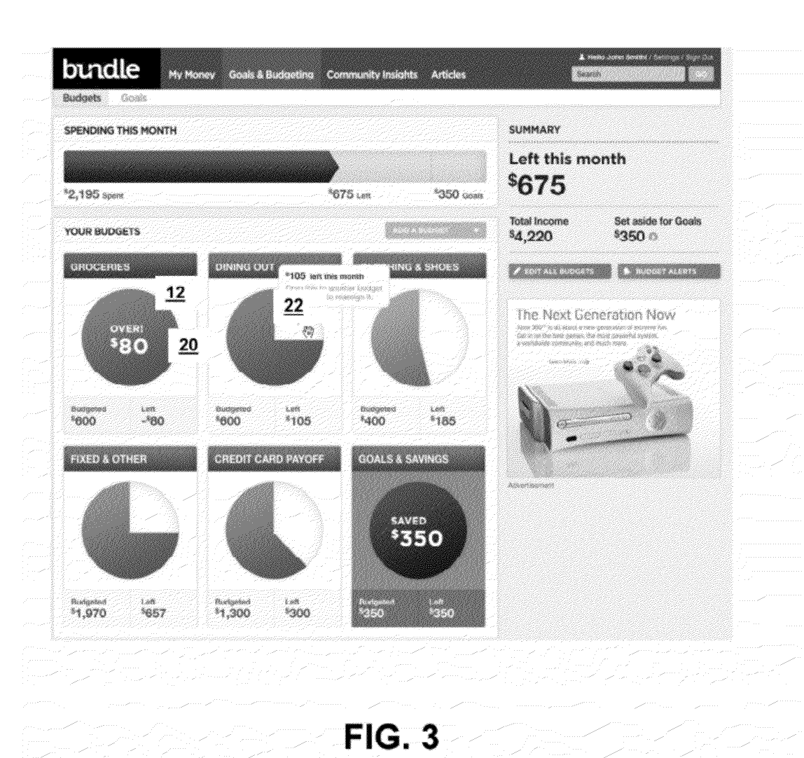

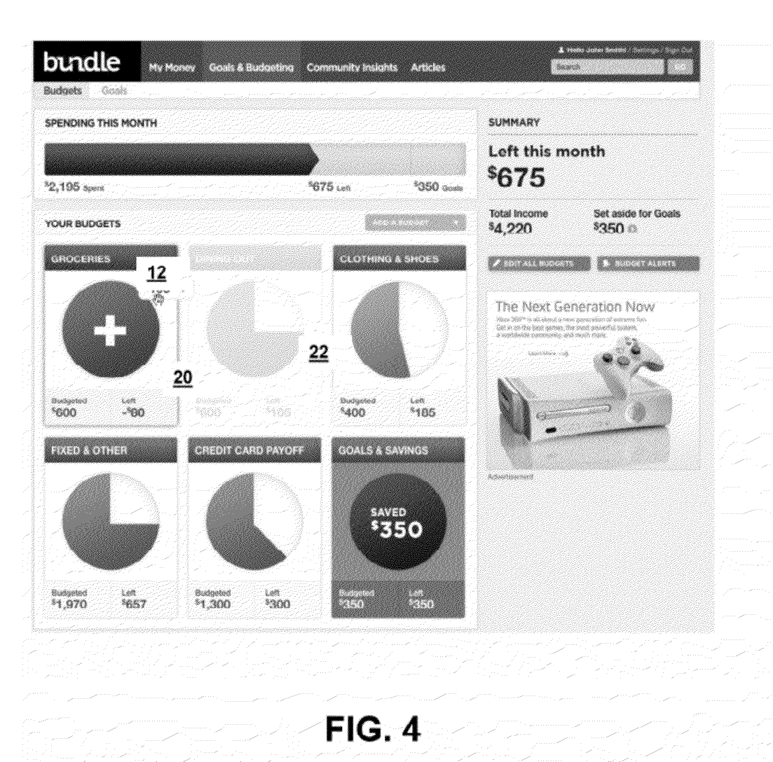

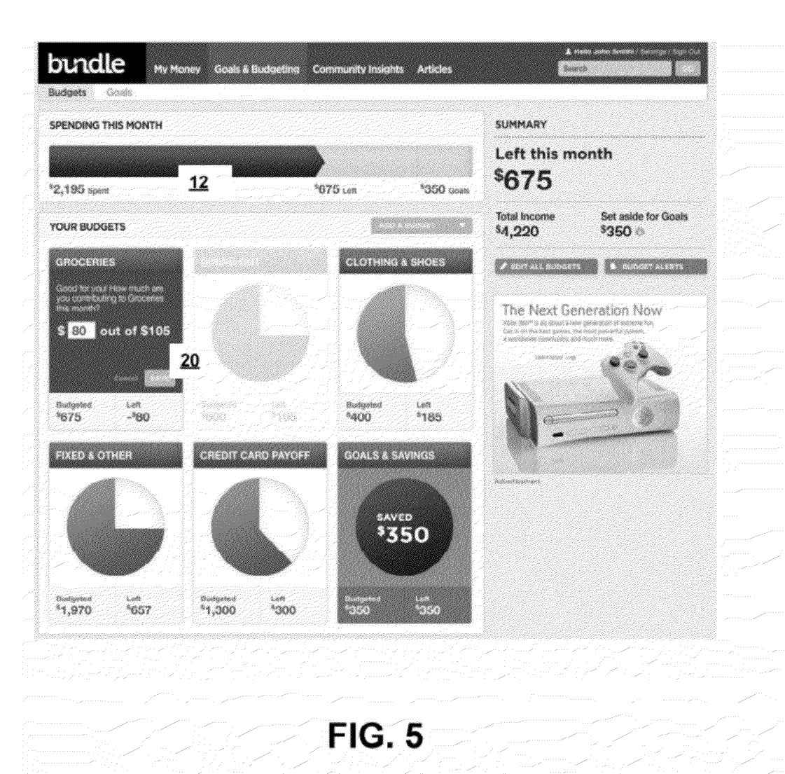

An example of a query to the user to adjust the budgets is shown in FIG. 2. As indicated in area 12, the Groceries budget 20 is overspent by $80 and the Dining Out budget 22 has $105 remaining. When the user rolls a pointer over the “Left $105” area of the Dining Out budget 22, the program displays a prompt “Drag this to another budget if you want to reassign it”. The same prompt is displayed in FIG. 3 when the user rolls a pointer over the light section of the pie chart representing the budget 22, where the light section represents the $105 left in the Dining Out budget 22. As shown in FIG. 4, when the prompted portion is dragged to the Groceries budget 12, a plus sign indicates that the program is prepared to accept at least a portion of the excess from the Dining Out budget into the Groceries budget. This causes a prompt to be displayed, as in FIG. 5, requesting the user to input an amount that is to be transferred from the Dining Out budget to the Groceries budget 20. As indicated, the user chose to transfer $80 to the Groceries budget 20, satisfying the shortfall in that budget.

In other embodiments, the portion of the budget is moved from the second budgetary category to the first budgetary category without input from the user, for example when the user financial activity in the first budgetary category exceeds or is likely to exceed the calculated budget by at least a particular amount, and the user financial activity in the at least second budgetary category does not exceed or is not likely to exceed the calculated budget during the predetermined time after the portion of the budget is moved.

In various embodiments, a portion of a budget in a budgetary category is moved from at least a first predetermined time period (e.g., a month) to at least a second predetermined time period. This movement from one time period to another time period within the same budget may occur where the first predetermined time period is before the second predetermined time period, or where the first predetermined time period is after the second predetermined time period. This feature is useful, for example, when the user wants to set aside a portion of a budget for an expense in that budgetary category that would otherwise bring the budget for that category over the budgetary allocation. For example, the user may be planning a party in two months and may move a portion of the food budget from the current month, and/or from the food budget allocation in three months to increase the food budget in the period covering the party.

In another embodiment, the user may set one or more predetermined parameters regarding reallocation of the budget from a first budget category to a second budget category or from a first time period to a second time period, whereupon the system will automatically reallocate the budget upon one or more parameters being met. Alternatively, the user may reallocate the budget at any time and for any reason by accessing the system.

These methods also provides a means for allocating an amount of the finances to at least one user financial goal. In these embodiments, the user financial goal comprises a desired future purchase or a desired future savings, and has a monetary value. An example of a display for a goal allocation module is shown in FIG. 1 as a Goals & Savings budget 24. That budget may be further explored and modified by clicking the Goals tab 26. The Goals & Savings budget 24 provides a summary of allocated portions of the user income that is set aside toward savings or a particular purchase, e.g., a consumer item, a down payment on real property, etc. The program allocates a designated portion of the amount “Left”, as indicated in area 10, to the Goals & Savings. Under that Goals tab, the program displays summaries of desired savings and goals for the future purchases. In some embodiments, the program further presents to the user on the display a timeline showing progress toward achieving each financial goal.

In some embodiments, these methods are performed on an individual computer, for example a home computer. However, the methods can also be advantageously performed over a network, for example the World Wide Web (i.e., the Internet). In those methods, the processor and memory are connected to the display via a network. In those embodiments, the method can access external sources of information, for example accessory information, or bank websites to download information of user income and/or spending.

Also provided is a system for managing a budget of a user. The system comprises (a) a processor, wherein the processor (i) runs a software application that obtains information regarding at least two budgetary categories where finances of the user are to be allocated, and an amount of the finances to be allocated in the at least two budgetary categories; (ii) presents the budgetary categories to the user; (iii) determines a budget for the user during a predetermined time period for the at least two budgetary categories using the obtained information; (iv) obtains data regarding financial activity by the user during the predetermined time period in the at least two budgetary categories; (v) determines whether the user financial activity during the predetermined time period in the at least two budgetary categories exceeds or is likely to exceed the calculated budget; and (iv) notifies the user when the user spending during the predetermined time period in a first of the at least two budgetary categories exceeds or is likely to exceed the calculated budget; (b) a database coupled to the processor, wherein the database resides in at least one memory and stores the budget in the at least two budgetary categories; and (c) a display coupled to the processor, wherein the display presents the budgetary categories to the user and presents the notification from the processor to the user.

This system performs the methods described above, and features all of the characteristics of those methods.

Further provided is a computer program product to be used with a processor and a display. The computer program product comprises a computer usable medium comprising computer readable program code directing the processor to (a) obtain information regarding at least two budgetary categories where finances of a user are to be allocated, and an amount of the finances to be allocated in the at least two budgetary categories; (b) present the budgetary categories to the user on the display; (c) determine a budget for the user during a predetermined time period for the at least two budgetary categories using the obtained information; (d) obtain data regarding financial activity by the user during the predetermined time period in the at least two budgetary categories; (e) determine whether the user financial activity during the predetermined time period in the at least two budgetary categories exceeds or is likely to exceed the calculated budget; and (f) notify the user on the display when the user spending during the predetermined time period in a first of the at least two budgetary categories exceeds or is likely to exceed the calculated budget.

This computer program product executes the system and methods described above, featuring all of the characteristics of that system and those methods. The computer program can reside on an individual computer such as a home computer. Alternatively, the computer program can reside on a computer server remote from the display and the user.

As indicated in FIG. 1, the methods described herein are practiced on a computer through the interaction of the user with a computer program. The interaction can operate using any computer system available. For example, the processor of FIG. 1, along with the display, can be on a laptop, desktop or handheld (e.g., Smartphone or iPad-type device) computer accessed by the user. Alternatively, the processor can be at a remote location, e.g., a server accessed by the user over the Internet. The computer program could also utilize the processor accessed by the user for some tasks and a remote processor for other tasks. Similarly, the memory utilized in the methods, systems and computer programs described herein can be on the computer accessed by the user, on a computer at a remote location, or both (i.e., some memory functions utilized on the user's computer and other memory functions utilized on a remote server). The data accessed in the methods (e.g., user income and spending, passwords, etc.) can also be stored on a remote computer and/or the user's computer. In some embodiments, the data is stored on a remote computer and the user's computer only accesses and stores data while it is being analyzed, utilized and/or displayed by the display on the user's computer.

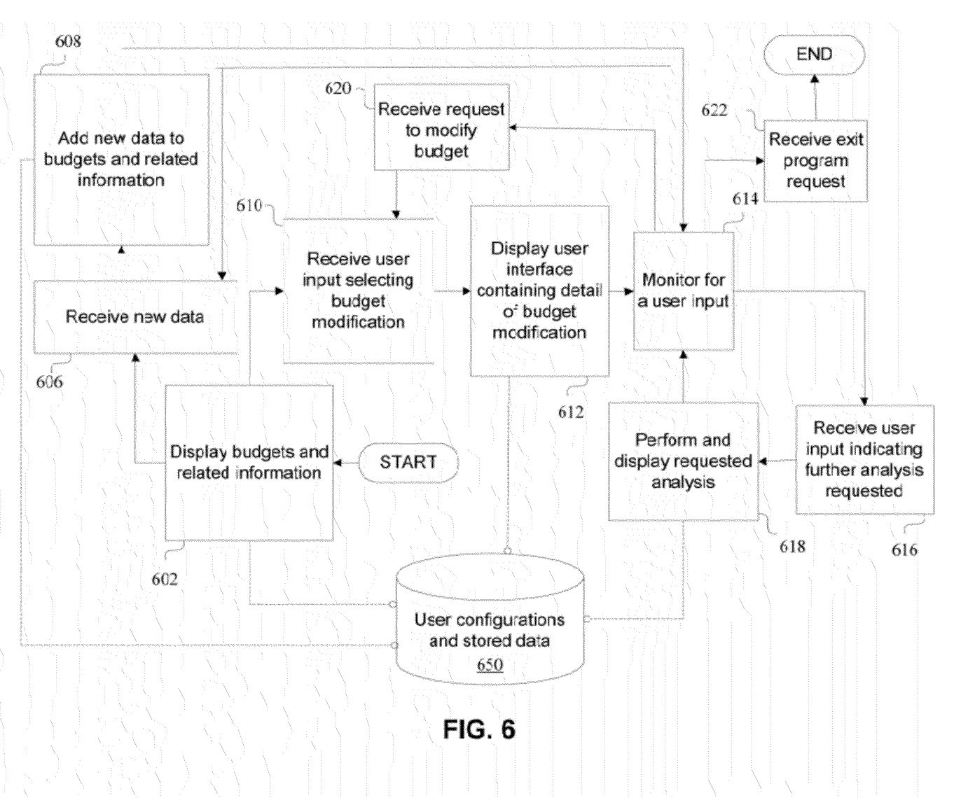

FIG. 6 summarizes the flow of information in some embodiments of the disclosed methods, systems and computer programs. The user configurations and stored data reside on a data storage device or memory 650, on the computer that the user is operating or at a remote location, e.g., connected to the user's computer through the Internet, or both. Upon starting, the program displays budgets and related information 602, e.g., the budgetary categories and the amount allocated to each category, as in FIGS. 2-5. If new information is received 606, e.g., by user input or program retrieving the information from a database, the program adds the new data to the budgets and related information, and calculates any appropriate changes to the budgets and related information (e.g., changes in the amount spent in each budgetary category and the amount left in the relevant budget(s)) resulting from the new data 608. The program is also capable of receiving user input selecting budget modification 610, and responds by displaying a user interface containing details and effects of the selected budget modification 612, then monitors for a user input 614. The input results in (a) the receipt of new data 606, (b) the receipt of a request to modify the budget 620, (c) a request for further analysis 616 (e.g., enter the Goals section and modify goals and savings allocations), or (d) a request to exit the program 622, the latter action resulting in an end to the session. If further analysis is requested 616, the program performs and displays the requested analysis 618.

Computer program instructions for executing the disclosed embodiments may be stored in a computer-readable medium that can direct a computer or other programmable data processing apparatus to function in a particular manner, such that the instructions stored in the computer-readable medium produce instruction means which implement the function/act specified in the flowchart. The computer program instructions may also be loaded onto a data processing apparatus to cause a series of operational steps to be performed on the data processing system to produce a computer implemented process such that the instructions which execute on the data processing system provide processes for implementing the functions/acts specified in FIGS. 1 and 6 and as described above.

Embodiments involving computer software and hardware generally execute algorithms which implement method embodiments. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the present disclosure, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various embodiments may be implemented with the aid of computer-implemented processes or methods (a.k.a. programs or routines) that may be rendered in any computer language including, without limitation, C#, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ and the like. In general, however, all of the aforementioned terms as used herein are meant to encompass any series of logical steps performed in a sequence to accomplish a given purpose.

Embodiments may be implemented with apparatus to perform the operations described herein. This apparatus may be specially constructed for the required purposes, or may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

One of ordinary skill in the art will immediately appreciate that the teachings of the present disclosure may be practiced with computer system configurations other than those described above, including hand-held devices, multiprocessor systems, microprocessor-based or programmable consumer electronics, DSP devices, network PCs, minicomputers, mainframe computers, and the like, as well as in distributed computing environments where tasks are performed by remote processing devices that are linked through a communications network.

Other embodiments within the scope of the claims herein will be apparent to one skilled in the art from consideration of the specification or practice of the invention as disclosed herein. It is intended that the specification be considered exemplary only, with the scope and spirit of the invention being indicated by the claims.

In view of the above, it will be seen that the several advantages of the invention are achieved and other advantages attained.

As various changes could be made in the above methods and compositions without departing from the scope of the invention, it is intended that all matter contained in the above description and shown in the accompanying drawings shall be interpreted as illustrative and not in a limiting sense.

All references cited in this specification are hereby incorporated by reference. The discussion of the references herein is intended merely to summarize the assertions made by the authors and no admission is made that any reference constitutes prior art. Applicants reserve the right to challenge the accuracy and pertinence of the cited references.

1. A method implemented using a processor, a memory and a display device for managing a budget of a user, the method comprising
obtaining information regarding
at least two budgetary categories where finances of the user are to be allocated, and
an amount of the finances to be allocated in the at least two budgetary categories;
presenting the budgetary categories to the user via the display device;
determining a budget for the user during a predetermined time period for the at least two budgetary categories using the obtained information;
obtaining data regarding financial activity by the user during the predetermined time period in the at least two budgetary categories;
using the processor to determine whether the user financial activity during the predetermined time period in the at least two budgetary categories exceeds or is likely to exceed the calculated budget; and
notifying the user when the user financial activity during the predetermined time period in a first of the at least two budgetary categories exceeds or is likely to exceed the calculated budget.

2. The method of claim 1, wherein the information is at least partially obtained from at least one database.

3. The method of claim 2, wherein the at least one database comprises a financial account of the user.

4. The method of claim 2, wherein the at least one database provides averages of financial activity in the at least two budgetary categories by people in a similar socioeconomic class as the user.

5. The method of claim 1, wherein the information is at least partially obtained from the user.

6. The method of claim 1, wherein the information is at least partially obtained from the user in response to a query on the display device requesting input from the user.

7. The method of claim 1, wherein the financial activity is spending, payment of a loan, a fixed expense, an investment, saving, or a goal.

8. The method of claim 1, further comprising
moving a portion of the budget from at least a second budgetary category to the first budgetary category to increase the allocated amount in the first budgetary category if user financial activity during the predetermined time period in the first budgetary category exceeds or is likely to exceed the calculated budget, if a predetermined condition is met.

9. The method of claim 8, wherein the predetermined condition is met by the user instructing the processor to move the portion of the budget from the second budgetary category to the first budgetary category.

10. The method of claim 8, wherein the predetermined condition is met by
the user financial activity in the first budgetary category exceeding or likely exceeding the calculated budget by at least a particular amount, and
the user financial activity in the at least second budgetary category does not exceed or is not likely to exceed the calculated budget during the predetermined time after the portion of the budget is moved.

11. The method of claim 1, further comprising
moving a portion of a budget in a budgetary category from at least a first predetermined time period to at least a second predetermined time period.

12. The method of claim 11, wherein the first predetermined time period is before the second predetermined time period.

13. The method of claim 12, wherein the first predetermined time period is after the second predetermined time period.

14. The method of claim 1, wherein the budget for each of the at least two budgetary categories is shown on the display device as a first shape.

15. The method of claim 14, wherein the first shape is a circle, an oval, a square, a rectangle, a bar, a triangle, a pentagon, a hexagon, a heptagon, an octagon, or a parallelogram.

16. The method of claim 14, wherein the first shape is divided into a used portion and an unused portion in response to the user financial activity in the at least one budgetary category during the predetermined time period.

17. The method of claim 16, wherein the first shape comprises a smaller shape within the first shape, the smaller shape representing the unused portion.

18. The method of claim 16, wherein the first shape is a circle that is divided as a pie chart to indicate a proportion of the budget that is used in the at least one budgetary category during the predetermined time period.

19. The method of claim 14, wherein the first shape decreases in size as the unused portion of the budget decreases.

20. The method of claim 14, wherein the first shape representing the budget for each budgetary category is colored with a color that is unique for the budget for the corresponding budgetary category.

21. The method of claim 19, wherein the first shape for the budget for all of the budgetary categories are represented by a single type of shape.

22. The method of claim 21, wherein the single type of shape is a circle.

23. The method of claim 1, wherein the predetermined time period is one month.

24. The method of claim 16, wherein the first shape for each of the at least two budgetary categories is labeled with the budgetary category, the value of the budget corresponding to that shape, the value of the used portion, and the value of the unused portion.

25. The method of claim 1, further comprising presenting on the display a summary bar showing the sum of the amount used in all of the budgetary categories during the predetermined time period as a proportion of the sum of the budgets in all of the budgetary categories during the predetermined time period.

26. The method of claim 1, further comprising obtaining a user financial account balance and presenting the user financial account balance on the display.

27. The method of claim 1, further comprising allocating an amount of the finances to at least one user financial goal, wherein the at least one user financial goal
comprises a desired future purchase or a desired future savings, and
has a monetary value.

28. The method of claim 27, wherein the at least one user financial goal is divided into a saved portion and an unsaved portion, wherein the saved portion represents the portion of the desired future purchase or desired future savings that has already been set aside and the unsaved portion represents the portion of the desired future purchase or desired future savings that has not been set aside.

29. The method of claim 28, wherein the value of the user financial goal is represented on the display by a second shape.

30. The method of claim 27, wherein contributions to the financial goal are obtained at least in part from a portion of a budget for the predetermined time period that is unspent.

31. The method of claim 27, further comprising presenting to the user on the display a timeline showing progress toward achieving the financial goal.

32. The method of claim 1, wherein the processor and memory are coupled to the display via a network.

33. The method of claim 1, wherein the notifying is accomplished by presenting information to the user on the display regarding the first of the at least two budgetary categories exceeding or likely exceeding the calculated budget.

34. A system for managing a budget of a user, the system comprising:
(a) a processor, wherein the processor
(i) runs a software application that obtains information regarding
at least two budgetary categories where finances of the user are to be allocated, and
an amount of the finances to be allocated in the at least two budgetary categories;
(ii) presents the budgetary categories to the user;
(iii) determines a budget for the user during a predetermined time period for the at least two budgetary categories using the obtained information;
(iv) obtains data regarding financial activity by the user during the predetermined time period in the at least two budgetary categories;
(v) determines whether the user financial activity during the predetermined time period in the at least two budgetary categories exceeds or is likely to exceed the calculated budget; and
(iv) notifies the user when the user spending during the predetermined time period in a first of the at least two budgetary categories exceeds or is likely to exceed the calculated budget;
(b) a database coupled to the processor, wherein the database resides in at least one memory and stores the budget in the at least two budgetary categories; and
(c) a display coupled to the processor, wherein the display presents the budgetary categories to the user and presents the notification from the processor to the user.

35. A computer program product to be used with a processor and a display, the computer program product comprising:
a computer usable medium comprising computer readable program code directing the processor to
(a) obtain information regarding
at least two budgetary categories where finances of a user are to be allocated, and
an amount of the finances to be allocated in the at least two budgetary categories;
(b) present the budgetary categories to the user on the display;
(c) determine a budget for the user during a predetermined time period for the at least two budgetary categories using the obtained information;
(d) obtain data regarding financial activity by the user during the predetermined time period in the at least two budgetary categories;
(e) determine whether the user financial activity during the predetermined time period in the at least two budgetary categories exceeds or is likely to exceed the calculated budget; and
(f) notify the user on the display when the user spending during the predetermined time period in a first of the at least two budgetary categories exceeds or is likely to exceed the calculated budget.
